(19) United States
(12) Patent Application Publication
(10) Pub. No.: US 2007/0178351 A1
(43) Pub. Date: Aug. 2, 2007

(54) Fuel supply device and fuel cell

(75) Inventor: Shuichiro Saito, Kanagawa-ken (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 10/599,100

(22) PCT Filed: Mar. 18, 2005
(86) PCT No.: PCT/JP05/05609

§ 371 Date: Sep. 19, 2006

(30) Foreign Application Priority Data
Mar. 25, 2004 (JP) 2004-089535

(51) Int. Cl. H01M 8/04; B67D 5/40

(52) U.S. Cl. 429/34; 222/380; 429/22

(57) ABSTRACT

In a fuel supply device which supplies a fuel gas introduced from a fuel cartridge 3 to a fuel cell thorough a flow passage 40, the fuel supply device has: a fuel introduction valve 4 that introduces the fuel gas into the flow passage from the fuel cartridge; a purge valve 17 that discharges any gas other than the fuel gas introduced into the flow passage from the flow passage to effect gas replacement; and a fuel supply valve 19 that supplies the fuel gas introduced into the flow passage to a fuel cell main body, wherein the fuel gas is supplied to the fuel cell by controlling the fuel introduction valve 4, the purge valve 17, and the fuel supply valve 19 through at least one of mechanical operation and electrical operation performed from outside.

### TECHNICAL FIELD

The present invention relates to a fuel supply device and a fuel cell, and more particularly to a fuel supply device for supplying fuel to a fuel cell using a gas such as hydrogen, as the fuel, and to a fuel cell detachable with respect to an apparatus.

### BACKGROUND ART

Recently, environmental destruction has become an issue, and there is a demand for a clean energy involving no harmful wastes. Further, exhaustion of fossil fuels has become an issue, and there is a demand for a new energy source. On the other handy in the field of electronics, as a result of the increase in information volume, there has been a marked expansion in information processing capacity, and there is a tendency for the power consumption by an electronic apparatus to increase.

In view of this, attention is being focused on hydrogen as an energy source, which is contained in water inexhaustible on the earth and which provides great chemical energy but involves no discharge of a harmful substance. In particular, the fuel cell, which makes it possible to directly extract electric energy, exhibits high hydrogen utilization efficiency and makes it possible to extract great power, so that its application, starting from automotive uses, is being extended to various types of portable electronic apparatus, such as a notebook computer, a mobile phone, and a video camera.

A so-called fuel cell, which extracts electric energy from hydrogen, has a hydrogen electrode to which hydrogen is supplied and an oxidation electrode to which oxide is supplied; at the hydrogen electrode, hydrogen is separated into electrons and protons, of which the protons pass through an electrolyte membrane to reach the oxidation electrode, where they react with oxygen by catalytic reaction to produce water; in this process, an electron flow, that is, electric power is generated.

Unlike the conventional secondary battery, the fuel cell requires no charging; when the fuel has been used up, power generation is possible as soon as fuel is supplemented, which is convenient for long term use (see International Publication No. WO 03/049223).

### DISCLOSURE OF INVENTION

In this way, in the fuel cell, which allows extraction of electric energy anytime anywhere by supplementing fuel, treats, unlike the conventional batteries, a gas such as hydrogen.

When replacing the fuel cartridge, it is necessary to temporarily detach the fuel cartridge from the fuel cell main body, and, in this process, atmospheric air is allowed to enter the fuel cell main body. This results in a marked reduction in the output of the fuel cell, and, in many cases, the reaction of the fuel cell stops. Thus, it is indispensable, at the time of fuel replacement, to replace any gas in the fuel cell main body other than the fuel gas by fuel gas.

Further, apart from the replacement of the fuel cartridge, a similar gas replacement is necessary when a gas other than fuel gas is allowed to enter the fuel cell main body.

Further, in a fuel cell, when the circuit to the load is interrupted, the reaction stops, and there is basically no fuel gas consumption. However, discharge or the like occurs in the wiring portion connected to the load, and the fuel gas is gradually consumed. Thus, when the operation of the fuel cell is stopped, it is necessary to interrupt the fuel gas supply in order to eliminate unnecessary consumption of fuel gas.

The present invention has been made in view of the above problems in the prior art. It is an object of the present invention to propose a fuel supply device capable of effecting gas replacement from outside the fuel cell when a gas other than the fuel gas enters the fuel cell main body.

Another object of the present invention is to propose a fuel supply device which, when the main switch of the apparatus is turned off, closes a valve provided in the fuel gas supply flow passage to interrupt the fuel gas supply to the fuel cell, making it possible to eliminate unnecessary consumption of the fuel gas.

A further object of the present invention is to propose a fuel cell equipped with a fuel supply device capable of effecting gas replacement from outside the fuel cell and of eliminating unnecessary fuel gas consumption.

That is, according to a first aspect of the present invention, there is provided a fuel supply device which supplies a fuel gas introduced from a fuel cartridge to a fuel cell through a flow passage, including: a fuel introduction valve that introduces the fuel gas into the flow passage from the fuel cartridge; a purge valve that discharges any gas other than the fuel gas introduced into the flow passage from the flow passage to effect gas replacement; and a fuel supply valve that supplies the fuel gas introduced into the flow passage to a fuel cell main body, wherein the fuel gas is supplied to the fuel cell by controlling the fuel introduction valve, the purge valve, and the fuel supply valve through at least one of mechanical operation and electrical operation performed from outside.

It is preferable that the control of the fuel introduction valve, the purge valve, and the fuel supply valve be effected through mechanical and electrical operation based on a command from an external apparatus in which the fuel cell is mounted.

According to a second aspect of the present invention, there is provided a fuel supply device which supplies a fuel gas introduced from a fuel cartridge to a fuel cell through a flow passage, including: a fuel introduction valve that introduces the fuel gas into the flow passage from the fuel cartridge; a purge valve that discharges any gas other than the fuel gas introduced into the flow passage from the flow passage to effect gas replacement; a fuel movement valve that controls a pressure of the fuel gas in the flow passage to move the fuel gas; and a fuel supply valve which supplies the fuel gas introduced into the flow passage to a fuel cell main body, wherein the fuel gas is supplied to the fuel cell by controlling the fuel introduction valve, the purge valve, and the fuel supply valve through at least one of mechanical operation and electrical operation performed from outside.

It is preferable that the fuel movement valve be provided in the flow passage, and that movement of the fuel gas be effected through control of the pressure of the fuel gas by a diaphragm.

It is preferable that the control of the fuel introduction valve, the purge valve, and the fuel supply valve be effected through mechanical and electrical operation based on a command from an external apparatus in which the fuel cell is mounted.

Further, according to a third aspect of the present invention, there is provided a fuel cell including the fuel supply device as described in the first or second aspect and a detachable fuel cartridge.

Further, there is provided an apparatus including the fuel cell as described above.

The fuel supply device of the present invention is capable of performing gas replacement from outside the fuel cell when a gas other than the fuel gas is allowed to enter the fuel cell main body.

Further, in the fuel supply device of the present invention, when the main switch of the apparatus is turned off, a valve provided in the fuel gas supply flow passage is closed to interrupt the fuel gas supply to the fuel cell, making it possible to eliminate unnecessary consumption of the fuel gas.

Further, according to the present invention, it is possible to provide a fuel cell equipped with a fuel supply device capable of effecting gas replacement from outside the fuel cell and of eliminating unnecessary fuel gas consumption.

### BRIEF DESCRIPTION OF THE DRAWINGS

FIG. 1 is a central sectional view of a main portion of a fuel cell according to an embodiment of the present invention.

FIG. 2 is a schematic view of a fuel cell main body and a fuel cartridge.

FIG. 3 is a perspective view of the fuel cartridge portion of FIG. 2.

FIG. 4 is a flowchart showing an operation of a fuel cell.

FIG. 5 is a central sectional view of a main portion of a fuel cell according to another embodiment of the present invention.

FIG. 6 is a schematic view of a fuel cell main body and a fuel cartridge.

FIG. 7 is a perspective view of the fuel cartridge portion of FIG. 6.

FIG. 8 is a block diagram related to an operation of a fuel cell.

FIG. 9 is a flowchart showing an operation of a fuel cell.

FIG. 10 is a flowchart showing an operation of a fuel cell.

### BEST MODE FOR CARRYING OUT THE INVENTION

In a fuel supply device of the present invention, in order to achieve the above objects, connection of a fuel cartridge to a fuel cell is detected, and a gas replacement operation is automatically conducted. Alternatively, an output of the fuel cell is detected, and when a predetermined voltage has not been generated, the gas replacement operation is conducted. Alternatively, gas replacement is conducted in synchronism with the turning-on of a main switch of a portable electronic apparatus, such as a personal computer, a mobile phone, a digital camera, or a digital video recorder.

Further, in the present invention, there is provided a fuel supply device supplying fuel gas introduced from a fuel cartridge to a fuel cell through a flow passage, wherein a valve is provided in the flow passage connecting the fuel cell main body and the fuel cartridge, and wherein the valve is operated in synchronism with a main switch of the apparatus, that is, the valve is opened when the main switch of the apparatus is on and closed when the main switch is off, whereby fuel gas is supplied to a reaction portion only when necessary, thus eliminating wasteful consumption of fuel gas.

### EMBODIMENT 1

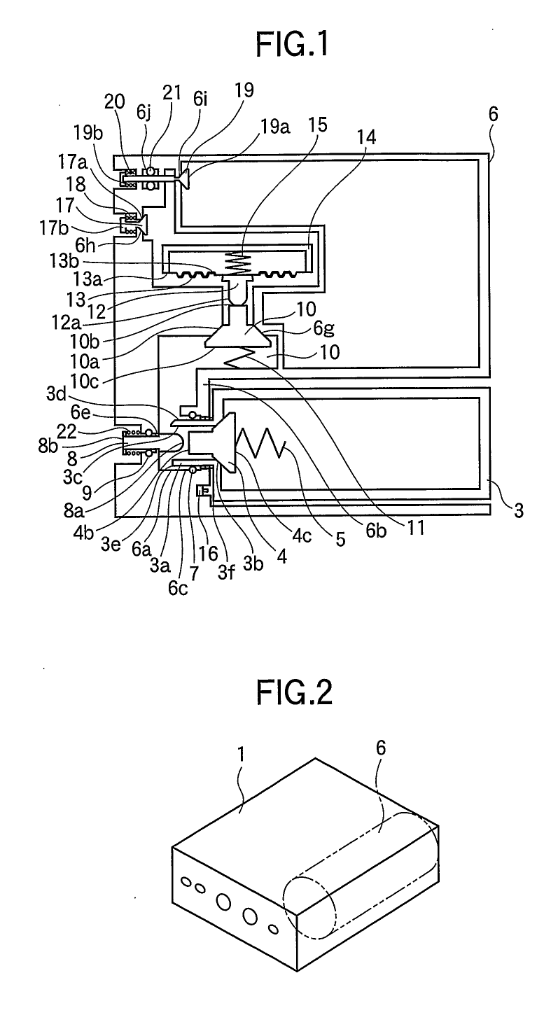

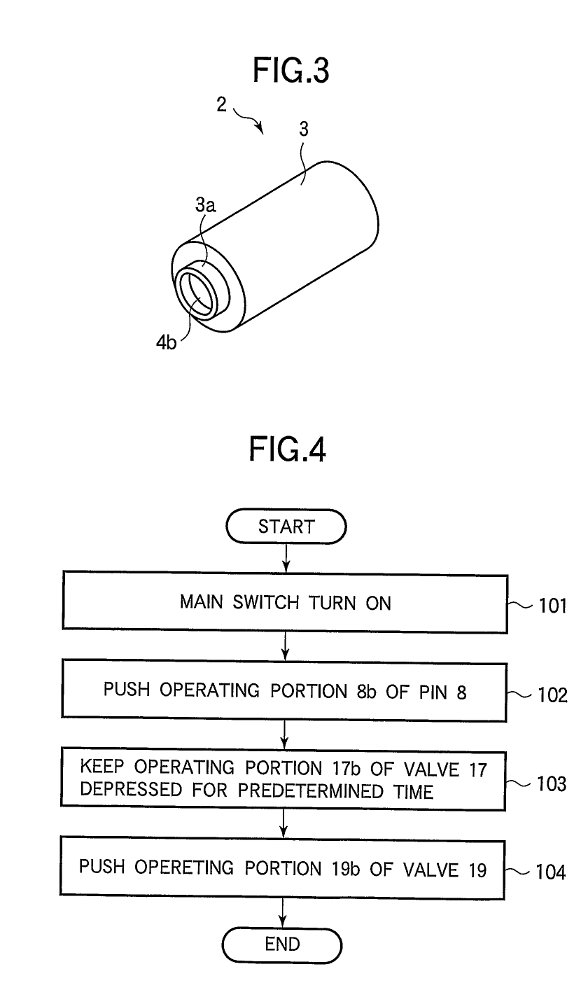

A fuel supply device and a fuel cell according to a preferred embodiment of the present invention will be described with reference to the drawings. FIG. 1 is a central sectional view of a main portion of a fuel cell according to a preferred embodiment of the present invention. FIG. 2 is an outward view showing how a fuel cell main body and a fuel cell cartridge are connected together. A fuel cartridge 2 can be inserted from outside a fuel cell main body 1. FIG. 3 is a perspective view of the fuel cartridge. Reference numeral 3 indicates the fuel cartridge casing; it may be filled with compressed hydrogen or of a construction in which hydrogen is occluded in a hydrogen occlusion alloy, such as Fe—Ti alloy or Ti—Mn alloy. Symbol 3a indicates a cover member described below, and symbol 4b indicates a valve protrusion.

The fuel supply device of the present invention is a device for supplying fuel gas introduced from the fuel cartridge to the fuel cell through a flow passage, and includes a fuel introduction valve 4 for introducing fuel gas from the fuel cartridge casing 3 to a flow passage 40, a purge valve 17 for performing gas replacement by discharging a gas other than the fuel gas introduced into the fuel passage 40 from the flow passage, a fuel movement valve 10 that controls the pressure of the fuel gas in the flow passage 40 to move the same, and a fuel supply valve 19 for supplying the fuel gas introduced into the flow passage 40 to the fuel cell main body, wherein the fuel introduction valve 4, the purge valve 17, and the fuel supply valve 19 are controlled through mechanical and electrical operation by a command from an external apparatus in which the fuel cell is mounted, thereby supplying fuel gas to the fuel cell.

First, in FIG. 1, reference numeral 6 indicates the casing of the fuel cell main body. Symbol 6a indicates a recess, into which the connecting portion of the fuel cartridge is inserted. Symbol 3a indicates a cover member, which is arranged around a protrusion 4b of the fuel introduction valve 4. The protrusion of the cover member is larger than the protrusion 4b. The fuel introduction valve 4 has a conical surface 4a, which is in contact with a conical surface 3b of the fuel cartridge so that no fuel gas may leak to the exterior. Reference numeral 5 indicates a compression spring, the right-hand end portion of which is fixed to a member (not shown) in the fuel cartridge, and the left-hand end portion of which pressurizes the bottom surface 4c of the fuel introduction valve 4. That is, by the hydrogen pressure and the force of the compression spring 5, the conical surfaces 3b and 4a are kept in contact with each other so that no hydrogen gas may leak to the exterior of the fuel cartridge.

The fuel introduction valve 4 and the cover member 3a are smaller than a finger of a child so that a finger of a child may not reach the protrusion 4b of the fuel introduction valve 4 in a hole 3c of the cover member.

Symbol 6a indicates a recess, in which a V-shaped shaped groove 6c is formed, with an O-ring 7 serving as a seal member being arranged therein. Symbol 3g indicates a screw portion provided on the cover member 3a. Reference numeral 16 indicates a micro switch, which is arranged so as to be turned on immediately before the fuel cartridge is fixed to the fuel cell main body.

Next, the operation of the fuel supply device will be described.

When the fuel cartridge 1 is inserted, a beveled portion 3e formed at the forward end of the cover member 3a abuts the seal member 7, and, while compressing the seal member 7, the cover member 3a moves to the left as seen in FIG. 1, with the seal member 7 coming into close contact with an outer surface 3d of the cover member 3a to keep the fuel flow passage airtight.

Symbol 6d indicates a screw portion provided in the recess 6a. After the seal member 7 is compressed by the recess 6a and the cover member 3a and the airtightness of the fuel flow passage has been secured, the screws 3g and 6d are engaged with each other, and the fuel cartridge 2 is fixed by screwing in the casing 3 of the fuel cartridge.

Reference numeral 8 indicates a pin, which is inserted into a hole 6e, preventing passage of gas between the exterior and interior by a seal member (O-ring) 9 arranged in a V-groove 6f. Reference numeral 22 indicates a compression spring, which urges the pin 8 to the left as seen in the drawing; in the state in which the fuel cartridge 3 is fixed, a spherical portion 8a of the pin is arranged, with some gap between it and the left hand end 4b of the fuel introduction valve 4.

By pushing an operating surface 8b of the pin 8 from outside, the fuel introduction valve 4 is opened, and hydrogen gas flows into the flow passage 40.

Reference numeral 10 indicates a fuel movement valve provided in the flow passage 40; it has a conical surface 10a, which is in contact with the conical surface 6g so that no further fuel gas may enter the interior of the fuel cell main body. Reference numeral 11 indicates a compression spring, whose lower end portion is fixed and whose upper end portion pressurizes the bottom surface 10c of the fuel movement valve 10. That is, by the hydrogen gas pressure and the force of the compression spring 11, the conical surfaces 10a and 6g are kept in contact with each other so that no further hydrogen gas may not enter the interior of the fuel cell main body.

Reference numeral 13 indicates a diaphragm, which has a disc-like configuration and an outer peripheral portion 13a of which is fixed to a casing 14 of a regulator main body. The casing 14 is fixed to a stationary member (not shown) in the fuel cell main body casing 6. The diaphragm 13 has at its center a flat portion 13b, to which a pin 12 is fixed; there are formed concentric, wave-like protrusions and recesses, which receive the pressure of the hydrogen on the lower side of the drawing and the pressure of the gas inside the casing 14. Further, through a change in the hydrogen gas pressure, the diaphragm 13 can be freely displaced in the vertical direction as seen in the drawing.

The lower end portion of the pin 12 as seen in the drawing is formed as a spherical surface 12a, which is held in contact with the protrusion 10b of the fuel movement valve 10. Reference numeral 15 indicates a compression spring one end of which is fixed to the interior of the casing 14 and the other end of which is fixed to the surface of the flat portion 13b of the diaphragm 13 on the opposite side of the surface thereof to which the pin is fixed.

Here, the operation will be described.

The pressure of the hydrogen flowing in through the fuel introduction valve 4 and the compression spring 11 cause a force to be exerted upwards as seen in the drawing. The pressure of the gas inside the casing 14 of the diaphragm and the compression spring 15 cause a force to be exerted downwards as seen in the drawing. The gas pressure around the diaphragm causes a force to act upon the diaphragm upwards as seen in the drawing. The positions of the pin 12 and the fuel movement valve 10 are determined by the resultant force of those forces. That is, when the pressure of the hydrogen around the diaphragm is at a predetermined value, the conical surface 10a of the fuel movement valve 10 is in contact with the conical surface 6g, and the flow of hydrogen gas from the fuel cartridge side into the interior of the fuel cell main body is stopped.

When, as a result of power generation, hydrogen gas is consumed, the pressure of the hydrogen gas around the diaphragm 13 is reduced, and the diaphragm 13 is displaced downwards as seen in the drawing. This causes the pin 12 to downwardly push the fuel movement valve 10 and displace the same to thereby cancel the contact between the conical surfaces 6g and 10a, allowing the hydrogen gas in the casing 3 of the fuel cartridge to flow into the flow passage 40.

As described above, the peripheral side of the diaphragm 13 is fixed to the casing 14 of the regulator, so that it is free from the influence of the ambient air pressure. Thus, by appropriately setting the pressure of the gas in the casing 14 of the regulator and the force of the compression spring 15, it is possible to maintain a desired hydrogen gas pressure. Instead of using the compression spring as shown in this embodiment, it is also possible to obtain a desired hydrogen gas pressure solely through the setting of the pressure of the gas inside the casing 14 of the regulator.

Reference numeral 17 indicates a purge valve for gas replacement, which has a conical surface 17aheld in contact with a conical surface 6h formed on the casing 6 of the fuel cell main body. Reference numeral 18 indicates a compression spring, which urges the purge valve 17 to the left as seen in the drawing. Due to the compression spring 18, the conical surfaces 18a and 6h are constantly held in contact with each other so that no gas inside the fuel cell main body may leak to the exterior. By pushing an operating portion 17b to the right from outside the fuel cell, the valve 17 is displaced to the right as seen in the drawing against the force of the compression spring 18, and the contact between the conical surfaces 17a and 6h is canceled, allowing the gas inside the fuel cell main body to flow out to the exterior.

Reference numeral 19 indicates a fuel supply valve which allows and prevents the flowing-in of hydrogen gas into the fuel cell reaction portion; it has a conical surface 19a, which abuts a conical surface 6I formed in the casing 6 of the fuel cell main body. Reference numeral 20 indicates a compression spring, which urges the fuel supply valve 19 to the left as seen in the drawing. Due to the compression spring 20, the conical surfaces 19a and 6I are constantly held in contact with each other, and no hydrogen gas is allowed to flow into the fuel cell reaction portion. By pushing an operating portion 19b from outside the fuel cell, the fuel supply valve 19 is displaced to the right as seen in the drawing against the force of the compression spring 20, and the contact between the conical surfaces 19a and 6I is canceled, allowing hydrogen gas to flow into the fuel cell reaction portion. Reference numeral 21 indicates a seal member (O-ring), which is arranged in a V-groove 6j so that no gas may be allowed to flow between the exterior and interior of the fuel cell.

Next, the operation of the fuel cell as a whole will be described.

The fuel cell main body 1 with the fuel cell cartridge 2 mounted therein is inserted into the battery space of the apparatus (which, in this embodiment, is a digital camera (not shown)); when the main switch of the digital camera is turned on, a pin or a lever interlocked with the main switch pushes the operating portion of, the pin 8; then, the hydrogen gas in the interior of the fuel cartridge casing 3 flows into the flow passage 40 through the fuel introduction valve 4.

Next, a pin or a lever (not shown) of the digital camera keeps the operating portion 17b of the purge valve 17 depressed for a predetermined period of time. As a result, gas replacement with hydrogen gas is effected in the fuel flow passage 40 up to the fuel supply valve 19, and any atmospheric component that was allowed to enter at the time of fuel cartridge replacement, etc., is removed, filling the fuel passage with pure hydrogen.

Subsequently, the operating portion 19b of the of the fuel supply valve 19 is pushed by the pin or the lever (not shown) of the digital camera, and hydrogen gas flows into the fuel cell reaction portion (not shown) to start power generation.

It is also possible to replace solely the fuel cartridge, with the fuel cell main body being attached to the digital camera. In this case, when a new fuel cartridge is inserted, a micro switch 16 is closed, and the purge valve 17 is kept open for a predetermined period of time by a microcomputer inside the digital camera, effecting gas replacement forcibly.

As described above, unlike the conventional batteries, the fuel cell does not start upon supply of fuel gas but requires gas replacement in the fuel flow passage. Further, to prevent wasteful fuel consumption, it is necessary to interrupt the flow passage when not in use. In the present invention, an actuator, a microcomputer, etc. are not arranged in the fuel cell, but there is arranged a mechanical interface so that various controls can be effected from the fuel-cell-mounted apparatus side, making it possible to supply an inexpensive fuel cell of a simple construction.

FIG. 4 is a flowchart illustrating the above-described operation.

When the main switch of the digital camera is turned on (101), the pin or the lever interlocked with the main switch pushes the operating portion of the pin 8 (102). Then, the hydrogen gas inside the fuel cell cartridge 3 flows into the flow passage 40 through the fuel introduction valve 4.

Next, the pin or the lever of (not shown) of the digital camera keeps the operating portion 17b of the purge valve 17 depressed for a predetermined period of time (103). As a result, gas replacement with hydrogen gas is effected in the fuel flow passage up to the fuel supply valve 19, and any atmospheric component that was allowed to enter at the time of fuel cartridge replacement, etc., is removed, filling the fuel flow passage with pure hydrogen.

Subsequently, the operating portion 19b of the fuel supply valve 19 is pushed by the pin or the lever (not shown) from the digital camera (104), and hydrogen gas flows into the fuel cell reaction portion (not shown), whereby power generation is started.

### EMBODIMENT 2

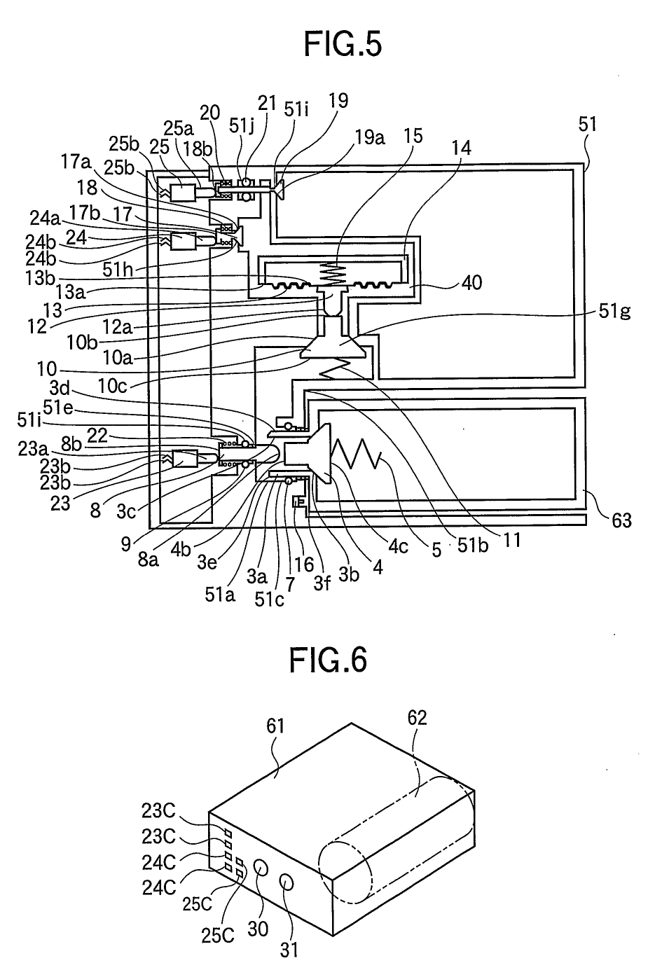

Next, a fuel cell according to a preferred embodiment having an electrical interface will be shown. FIG. 5 is a central sectional view of a fuel cell according to another embodiment of the present invention. In FIG. 5, the components that are the same as those of FIG. 1 are indicated by the same symbols. FIG. 6 is an outward view showing how a fuel cell main body 61 and a fuel cartridge 62 are connected together.

The fuel cartridge 62 can be inserted from outside the fuel cell main body 61. Contacts 30 and 31 arranged on the fuel cell main body 61 are output terminals for the electric power generated by the fuel cell. Symbols 23c, 24c, and 25c indicate contacts for power supply to an electromagnet described below and for control.

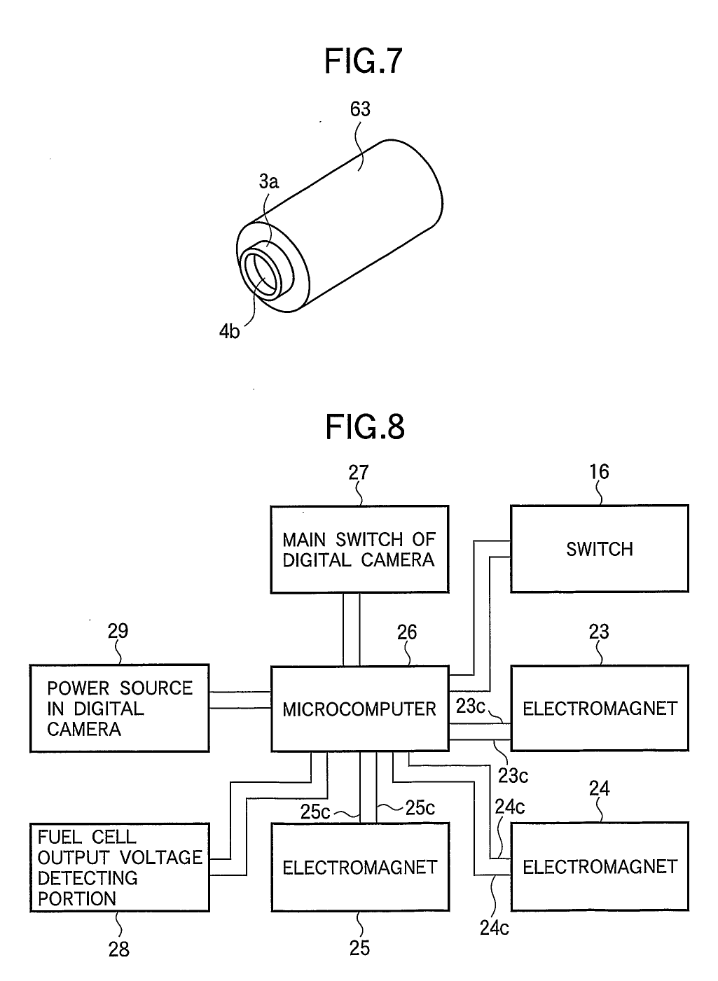

FIG. 7, which is a perspective view only showing the fuel cartridge, is the same as FIG. 3. Reference numeral 63 indicates a fuel cartridge casing; it may be filled with compressed hydrogen or of a construction in which hydrogen is occluded in a hydrogen occlusion alloy, such as Fe—Ti alloy or Ti—Mn alloy. Symbol 3a indicates a cover member described below, and symbol 4b indicates a valve protrusion.

FIG. 5 is the same as FIG. 1 except for an electromagnet portion and a fuel cell main body casing 51.

Reference numeral 51 indicates the casing of the fuel cell main body. Symbol 51a indicates a recess, into which a connecting portion of the fuel cartridge is inserted. Symbol 3a indicates a cover member, which is arranged around the protrusion 4b of the fuel introduction valve 4, the protrusion of the cover member being larger than the protrusion 4b. The fuel introduction valve 4 has a conical surface 4a, which is in contact with a conical surface 3b of the fuel cartridge so that no fuel gas may leak to the exterior. Reference numeral 5 indicates a compression spring, the right-hand end portion of which is fixed to a member (not shown) in the fuel cartridge, and the left-hand end portion of which pressurizes the bottom surface 4c of the fuel introduction valve 4. That is, by the hydrogen pressure and the force of the compression spring 5, the conical surfaces 3b and 4a are kept in contact with each other so that no hydrogen gas may leak to the exterior of the fuel cartridge.

The fuel introduction valve 4 and the cover member 3a are smaller than a finger of a child so that a finger of a child may not reach the protrusion 4b of the fuel introduction valve 4 in a hole 3c of the cover member.

Symbol 51a indicates a recess, in which a V-shaped groove 51c is formed, with an O-ring 7 serving as a seal member being arranged therein. Symbol 3g indicates a screw portion provided on the cover member 3a. Reference numeral 16 indicates a micro switch, which is arranged so as to be turned on immediately before the fuel cartridge is fixed to the fuel cell main body.

Next, the operation will be described.

When the fuel cartridge 61 is inserted, a beveled portion 3e formed at the forward end of the cover member 3a abuts the seal member 7, and, while compressing the seal member 7, the cover member moves to the left as seen in FIG. 4, with the seal member 7 coming into close contact with an outer surface 3d of the cover member 3a to keep the fuel flow passage airtight.

Symbol 51d indicates a screw portion provided in the recess 51a. After the seal member 7 is compressed by the recess 51a and the cover member 3a and the airtightness of the fuel flow passage has been secured, the screws 3g and 51d are engaged with each other, and the fuel cartridge 2 is fixed by screwing in the casing 63 of the fuel cartridge.

Reference numeral 8 indicates a pin, which is inserted into a hole 51e, preventing passage of gas between the exterior and interior by a seal member (O-ring) 9 arranged in a V-groove 51f. Reference numeral 22 indicates a compression spring, which urges the pin 8 to the left as seen in the drawing; in the state in which the fuel cartridge 63 is fixed, a spherical portion 8a of the pin is arranged, with some gap between it and the left hand end 4b, as seen in the drawing, of the fuel introduction valve 4.

By pushing an operating surface 8b of the pin 8 from outside, the fuel introduction valve 4 is opened, and hydrogen gas flows into the fuel gas main body. Reference numeral 23 indicates an electromagnet, and symbol 23a indicates a plunger; by supplying electricity through a lead line 23b, the plunger 23a moves to the right as seen in the drawing to displace the pin 8 to the right.

The lead line 23b is connected to the contacts 23c shown in FIG. 1.

Reference numeral 10 indicates a valve; it has a conical surface 10a, which is in contact with the conical surface 51g so that no further fuel gas may not enter the interior of the fuel cell main body. Reference numeral 11 indicates a compression spring, whose lower end portion is fixed and whose upper end portion pressurizes a bottom surface 10c of the fuel movement valve 10. That is, by the hydrogen gas pressure and the force of the compression spring 10, the conical surfaces 10a and 51g are kept in contact with each other so that no further hydrogen gas may enter the interior of the fuel cell main body.

Reference numeral 13 indicates a diaphragm, which has a disc-like configuration and whose outer peripheral portion 13a is fixed to a casing 14 of a regulator main body. The casing 14 is fixed to a stationary member (not shown) in the fuel cell main body casing 51. The diaphragm 13 has at its center a flat portion 13b, to which a pin 12 is fixed; there are formed concentric, wave-like protrusions and recesses, which receive the pressure of the hydrogen on the lower side of the drawing and the pressure of the gas inside the casing 14. Further, through a change in the hydrogen gas pressure, the diaphragm 13 can be freely displaced in the vertical direction as seen in the drawing.

The lower end portion of the pin 12 is formed as a spherical surface 12a, which is held in contact with a protrusion 10b of the fuel movement valve 10. Reference numeral 15 indicates a compression spring one end of which is fixed to the interior of the casing 14 and the other end of which is fixed to the surface of the flat portion 13b of the diaphragm 13 on the opposite side of the surface thereof to which the pin is fixed.

Here, the operation will be described.

The pressure of the hydrogen flowing in through the fuel introduction valve 4 and the compression spring 11 cause a force to be exerted upwards as seen in the drawing. The pressure of the gas inside the casing 14 of the diaphragm and the compression spring 15 cause a force to be exerted downwards as seen in the drawing. The gas pressure around the diaphragm causes a force to act upon the diaphragm 13 upwards as seen in the drawing. The positions of the pin 12 and the fuel movement valve 10 are determined by the resultant force of these forces. That is, when the pressure of the hydrogen around the diaphragm is at a predetermined value, the conical surface 10a of the fuel movement valve 10 is in contact with the conical surface 51g, and the flow of hydrogen gas from the fuel cartridge side into the interior of the fuel cell main body is stopped.

When, as a result of power generation, hydrogen gas is consumed, the pressure of the hydrogen gas around the diaphragm 13 is reduced, and the diaphragm 13 is displaced downwards as seen in the drawing. This causes the pin 12 to downwardly push the fuel movement valve 10 and displace the same to thereby cancel the contact between the conical surfaces 51g and 10a, allowing the hydrogen gas in the casing 63 of the fuel cartridge to flow into the hydrogen flow passage 40.

As described above, the peripheral side of the diaphragm 13 on the diaphragm 1 side is fixed to the casing 14 of the regulator, so that it is free from the influence of the ambient air pressure. Thus, by appropriately setting the pressure of the gas in the casing 14 of the regulator and the force of the compression spring 15, it is possible to maintain a desired hydrogen gas pressure. Instead of using the compression spring as shown in this embodiment, it is also possible to obtain a desired hydrogen gas pressure, solely through the setting of the pressure of the gas inside the casing 14 of the regulator.

Reference numeral 17 indicates a purge valve for gas replacement, which has a conical surface 17a held in contact with a conical surface 51h formed on the casing 51 of the fuel cell main body. Reference numeral 18 indicates a compression spring, which urges the purge valve 17 to the left as seen in the drawing. Due to the compression spring 18, the conical surfaces 18a and 51h are constantly held in contact with each other so that no gas inside the fuel cell main body may leak to the exterior. By pushing an operating portion 17b to the right as seen in the drawing from outside the fuel cell, the valve 17 is displaced to the right as seen in the drawing against the force of the compression spring 18, and the contact between the conical surfaces 17a and 51h is canceled, allowing the gas inside the fuel cell main body to flow out to the exterior. Reference numeral 24 indicates an electromagnet, and symbol 24a indicates a plunger; by supplying electricity through a lead line 24b, the plunger 24a is moved to the right as seen in the drawing, displacing the valve 17 to the right as seen in the drawing. The lead line 24b is connected to the contacts 24c shown in FIG. 1.

Reference numeral 19 indicates a fuel supply valve which allows and prevents the flowing-in of hydrogen gas into the fuel cell reaction portion; it has a conical surface 19a, which abuts a conical surface 51i formed in the casing 51 of the fuel cell main body. Reference numeral 20 indicates a compression spring, which urges the fuel supply valve 19 to the left as seen in the drawing. Due to the compression spring 20, the conical surfaces 19a and 51i are constantly held in contact with each other, and no hydrogen gas is allowed to flow into the flue cell reaction portion. By pushing an operating portion 19b from outside the fuel cell, the fuel supply valve 19 is displaced to the right as seen in the drawing against the force of the compression spring 20, and the contact between the conical surfaces 19a and 51i is canceled, allowing hydrogen gas to flow into the fuel cell reaction portion. Reference numeral 21 indicates a seal member (O-ring), which is arranged in a V-groove 51j so that no gas may be allowed to flow between the exterior and interior of the fuel cell. Reference numeral 25 indicates an electromagnet, and symbol 25a indicates a plunger; by supplying electricity through a lead line 25b, the plunger 25a is moved to the right as seen in the drawing, displacing the fuel supply valve 19 to the right as seen in the drawing. The lead line 25b is connected to the contacts 25c shown in FIG. 1.

FIG. 8 is a block diagram related to the operation of a fuel cell according to the present invention.

In the drawing, reference numeral 16 indicates the switch shown in FIG. 5, and reference numerals 23, 24, and 25 indicate the electromagnets shown in FIG. 5. Reference numeral 16 indicates the micro switch shown in FIG. 5.

Reference numeral 26 indicates a microcomputer provided in the apparatus in which the fuel cell main body is mounted, which, in this embodiment, is a digital camera, and reference numeral 27 indicates a main switch of the digital camera. Reference numeral 29 indicates a power source in the digital camera, which is used for the starting, control, etc., of the fuel cell. Reference numeral 28 indicates a fuel cell output voltage detecting portion.

Next, the operation will be described.

As is apparent from FIG. 5, when attaching the fuel cartridge, atmospheric air is allowed to enter through a hole 51a of the casing 51 of the fuel cell main body 51. In this state, the reaction of the fuel cell does not proceed.

When the fuel cell main body 61 and the fuel cartridge 62 are attached to the digital camera, power is supplied from the microcomputer to the electromagnet 23 through the contacts 23c and the lead line 23b, and the fuel introduction valve 4 is opened to supply hydrogen gas from the fuel cartridge. Next, power is supplied for a predetermined period of time from the microcomputer 26 to the electromagnet 24 through the contacts 24c and the lead line 24b, and the purge valve 17 is kept open for a predetermined period of time so that gas in the fuel flow passage is replaced with hydrogen gas, thereby filling the fuel flow passage with the hydrogen gas.

Next, power is supplied to the electromagnet 25 through the contacts 25c and the lead line 25b, and the fuel supply valve 19 is opened to supply hydrogen gas to the reaction portion (not shown) of the fuel cell.

When the fuel cartridge is replaced, with the fuel cell main body 61 attached to the digital camera, the micro switch 16 is turned on immediately before the attachment of the fuel cartridge is completed. The microcomputer 26 detects that the micro switch has been turned on, and supplies power to the electromagnet 23 through the contacts 23c and the lead line 23b, thereby opening the fuel introduction valve 4 for allowing hydrogen gas to be supplied from the fuel cartridge. Next, power is supplied from the microcomputer 26 to the electromagnet 24 for a predetermined period of time through the contacts 24c and the lead line 24b and the purge valve 17 is kept open for a predetermined period of time so that gas in the fuel flow passage is replaced with hydrogen gas, thereby filling the fuel flow passage with the hydrogen gas. Next, power is supplied to the electromagnet 25 through the contacts 25c and the lead line 25b, and the fuel supply valve 19 is opened to supply hydrogen gas to the reaction portion (not shown) of the fuel cell.

In this regard, it should be noted that no gas replacement occurs unless the gas pressure inside the fuel cell main body is higher than the atmospheric pressure; otherwise, atmospheric air will be allowed to enter. Thus, in the present invention, the gas pressure inside the fuel cell main body must always be set higher than the ambient atmospheric pressure.

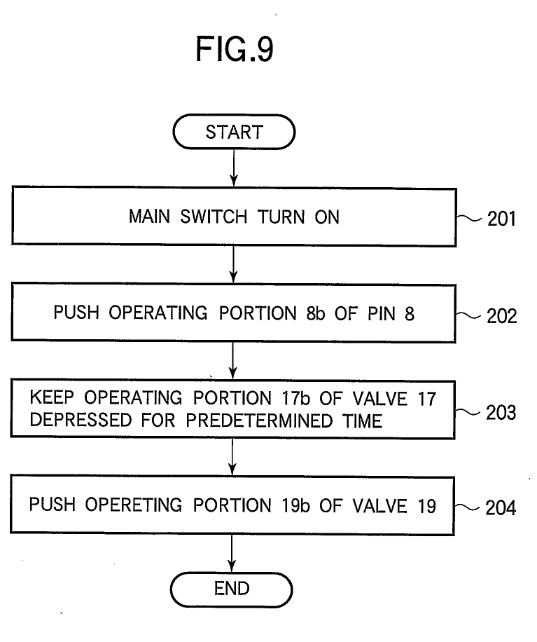

FIG. 9 is a flowchart illustrating the above-described operation.

When the main switch of the digital camera is turned on (201), power is supplied from the microcomputer to the electromagnet 23 through the contacts 23c and the lead line 23b, and the pin 8 is pushed (202), to open the fuel introduction valve 4 to allow hydrogen gas to be supplied from the fuel cartridge. Next, power is supplied from the microcomputer 26 to the electromagnet 24 through the contacts 24c and the lead line 24b for a predetermined period of time, and the purge valve 17 is kept open for a predetermined period of time (203) so that gas in the fuel flow passage is replaced with hydrogen gas, thereby filling the fuel flow passage with hydrogen gas. Next, power is supplied to the electromagnet 25 through the contacts 25c and the lead line 25b, and the fuel supply valve 19 is opened (204) to allow hydrogen gas to be supplied to the reaction portion (not shown) of the fuel cell to start power generation.

### EMBODIMENT 3

The next embodiment will be described.

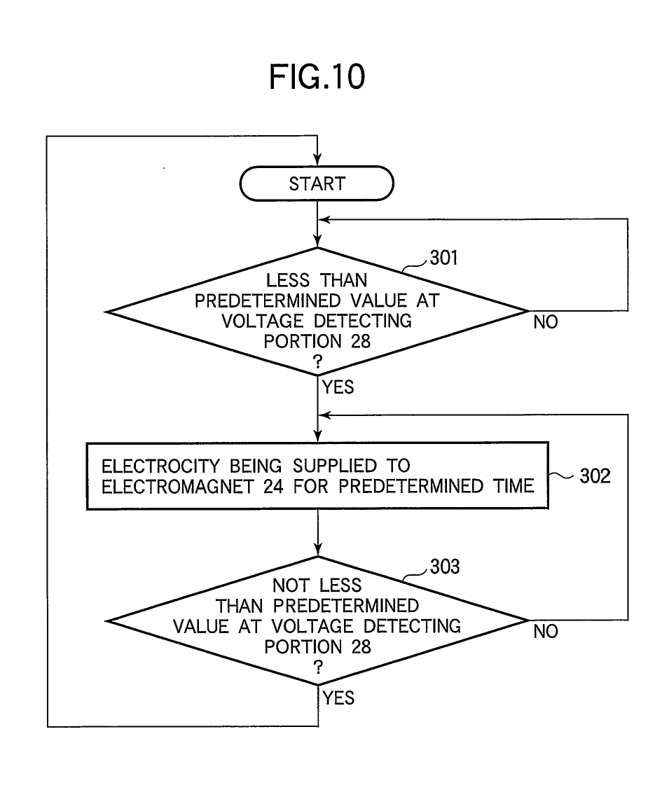

FIG. 10 is a flowchart for illustrating the operation.

In the digital camera of this embodiment, voltage is constantly detected by a fuel cell output voltage detecting portion 28; when the voltage becomes a predetermined value or less, the purge valve 17 is kept open for a predetermined period of time to effect gas replacement.

Alternatively, the purge valve 17 is kept open until the cell output attains a level not less than a predetermined value.

When a main switch 27 is on, the digital camera constantly detects voltage by the fuel cell output voltage detecting portion 28, and makes a judgment whether it is less than a predetermined value or not (301). When it is not less than the predetermined value, the procedure returns to the voltage detecting state, and the operation is conducted constantly or repeated at a predetermined time interval. When the voltage is less than the predetermined value, electricity is supplied to the electromagnet 24 for a predetermined period of time (302), and the purge valve 17 is kept open for a predetermined period of time to effect gas replacement. Next, the output voltage is detected, and a judgment is made as to whether it is not less than a predetermined value or not (303).

When it is less than the predetermined value, the procedure returns to the step where electricity is supplied to the electromagnet 24, and electricity is supplied to the electromagnet 24 again, the purge valve 17 being opened to effect gas replacement. When it is determined that the output voltage is not less than the predetermined value (303), the procedure returns to START, and the detection of the output voltage is continued.

In this embodiment, when operating the digital camera, the fuel cell is always operated in a normal fashion, allowing use without necessitating any operation of the fuel cell by the user.

When the main switch 27 is turned off, electricity ceases to be supplied to the electromagnets 23, 24, and 25, and the fuel introduction valve 4 is closed so that no hydrogen gas is supplied to the fuel cell main body. Further, the fuel supply valve 19 is closed, and the supply of hydrogen gas to the reaction portion in the fuel cell main body is also interrupted. This makes it possible to prevent hydrogen gas from being wasted.

As described above, the fuel cell is not immediately started upon supply of fuel gas thereto but requires gas replacement in the fuel flow passage. Further, to prevent wasteful fuel consumption, it is necessary to interrupt the fuel flow passage when not in use. In the present invention, an actuator is arranged in the fuel cell, and contacts for control and electricity supply are provided therein, making it possible to perform various controls from the fuel-cell-mounted apparatus side.

### INDUSTRIAL APPLICABILITY

The fuel cell having the fuel supply device of the present invention has, on its outer surface, the portions for controlling the fuel introduction valve, the purge valve, and the fuel supply valve mechanically and electrically, making it possible to perform the fuel supply control in the fuel cell from outside, in particular, from the fuel-cell-mounted apparatus side; thus, it is possible to provide a reliable and inexpensive fuel cell of a simple construction, which can be utilized as a fuel cell not only for automobiles but also for a portable electronic apparatus, such as a notebook computer, a mobile phone, and a video camera.

This application claims priority from Japanese Patent Application No. 2004-089535 filed Mar. 25, 2004, which is hereby incorporated by reference herein.

1. A fuel supply device which supplies a fuel gas introduced from a fuel cartridge to a fuel cell through a flow passage, comprising:
a fuel introduction valve that introduces the fuel gas into the flow passage from the fuel cartridge;
a purge valve that discharges any gas other than the fuel gas introduced into the flow passage from the flow passage to effect gas replacement; and
a fuel supply valve that supplies the fuel gas introduced into the flow passage to a fuel cell main body,
wherein the fuel gas is supplied to the fuel cell by controlling the fuel introduction valve, the purge valve, and the fuel supply valve through at least one of mechanical operation and electrical operation performed from outside.

2. The fuel supply device according to claim 1, wherein the control of the fuel introduction valve, the purge valve, and the fuel supply valve is effected through mechanical and electrical operation based on a command from an external apparatus in which the fuel cell is mounted.

3. The fuel cell comprising the fuel supply device as claimed in claim 1 and a detachable fuel cartridge.

4. An apparatus comprising the fuel cell as claimed in claim 3.

5. A fuel supply device which supplies a fuel gas introduced from a fuel cartridge to a fuel cell through a flow passage, comprising:
a fuel introduction valve that introduces the fuel gas into the flow passage from the fuel cartridge;
a purge valve that discharges any gas other than the fuel gas introduced into the flow passage from the flow passage to effect gas replacement;
a fuel movement valve that controls a pressure of the fuel gas in the flow passage to move the fuel gas; and
a fuel supply valve which supplies the fuel gas introduced into the flow passage to a fuel cell main body,
wherein the fuel gas is supplied to the fuel cell by controlling the fuel introduction valve, the purge valve, and the fuel supply valve through at least one of mechanical operation and electrical operation performed from outside.

6. The fuel supply device according to claim 5, wherein the fuel movement valve is provided in the flow passage, and movement of the fuel gas is effected through control of the pressure of the fuel gas by a diaphragm.

7. The fuel supply device according to claim 5, wherein the control of the fuel introduction valve, the purge valve, and the fuel supply valve is effected through mechanical and electrical operation based on a command from an external apparatus in which the fuel cell is mounted.

8. A fuel cell comprising the fuel supply device as claimed in claim 5 and a detachable fuel cartridge.

9. An apparatus comprising the fuel cell as claimed in claim 7.
